(19) United States
(12) Patent Application Publication
(10) Pub. No.: US 2018/0361598 A1
(43) Pub. Date: Dec. 20, 2018

(54) KNIFE WITH LINE CUTTER

(71) Applicant: JOHN R. WILLIAMS, Fayetteville, GA (US)

(72) Inventor: JOHN R. WILLIAMS, Fayetteville, GA (US)

(21) Appl. No.: 16/010,037

(22) Filed: Jun. 15, 2018

Related U.S. Application Data
(60) Provisional application No. 62/521,351, filed on Jun. 16, 2017.

(51) Int. Cl. B26B 11/00; B26B 29/02; B26B 3/06; A01K 97/00

(52) U.S. Cl. CPC B26B 11/00; A01K 97/00; B26B 3/06; B26B 29/025

(57) ABSTRACT

A knife with line cutter generally includes a knife blank having a main blade on one end and a line cutter on the opposing end of a tang. The line cutter has a sharpened edge on the inner curve of a hook at the end of the tang, and may extend from the handle or be recessed within the end of the handle. The tang may comprise a tang extension that allows the line cutter to transition from a retracted position to an extended position outside of the handle. The extension assembly may include a spring and/or a locking mechanism. Alternatively, the line cutter is a recessed diagonal blade. A method of forming a knife with line cutter generally includes forming a knife blank comprising a blade, tang, and line cutter; forming a handle; and securing the knife blank to the handle.

### RELATED APPLICATIONS

This application claims the benefit of U.S. Provisional Patent App. No. 62/521,351, filed Jun. 16, 2017, which is herein incorporated by reference for all purposes.

### TECHNICAL FIELD

The present disclosure generally relates to knives, and more particularly relates to knives with line cutters used for fishing.

### BACKGROUND

Fishermen often have to cut their lines, and there is a benefit to making it easy for them to cut lines without hassle. There is need in the art for a knife that allows a fisherman to cut a line quickly and cleanly without using their hands to manipulate a knife or pair of clippers.

### SUMMARY

A knife with line cutter generally includes a knife blank having a main blade on one end and a line cutter (a miniature blade) on the opposing end of a shaft or tang. The tang is secured inside a handle, and the line cutter is visible at the butt of the handle, including when the knife is sheathed. The line cutter comprises a sharpened edge or cutting surface along a concave or included-angle boundary of a finger-shielding barrier that extends from the end of the tang. The line cutter may extend from the handle or be recessed within the end of the handle.

In one embodiment, the tang comprises a tang extension that allows the line cutter to transition from a recessed position to an extended position outside of the handle. The extension assembly may include a spring and/or a locking mechanism.

In another embodiment, the line cutter is a diagonal blade recessed in the butt of the handle. In yet another embodiment, the line cutter is incorporated into a hook-shaped form that extends from the end of the tang.

A method of forming a knife with line cutter generally includes forming a knife blank comprising a blade, tang, and line cutter; forming a handle; and securing the tang in the handle such that the line cutter is at least visible at the butt of the knife.

Other systems, devices, methods, features, and advantages of the disclosed product and methods for forming a knife with line cutter will be apparent or will become apparent to one with skill in the art upon examination of the following figures and detailed description. All such additional systems, devices, methods, features, and advantages are intended to be included within the description and to be protected by the accompanying claims.

### BRIEF DESCRIPTION OF THE DRAWINGS

The present disclosure may be better understood with reference to the following figures. Corresponding reference numerals designate corresponding parts throughout the figures, and components in the figures are not necessarily to scale.

It will be appreciated that the drawings are provided for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

FIG. 1 is a side view of a filet knife with a line cutter in a hook.

FIG. 2 is a side view of a knife blank used to make the knife of FIG. 1.

FIG. 3 is a side view of the blank of FIG. 2 inserted into a handle (cutaway).

FIG. 4 is a perspective view from the opposite side of the knife of FIG. 3.

FIG. 5 is a perspective view of the butt of the knife of FIG. 4.

FIG. 6 illustrates a cap with hook for the butt of a knife.

FIG. 7 is a side view of a knife with an inset line cutter.

FIG. 8 is a side view of a knife blank with a two-piece tang.

FIG. 9 is a side view of a tang appendix for a moveable line cutter.

FIG. 10 is a side view of a knife with a diagonal line cutter and sheath.

### DETAILED DESCRIPTION

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Specific quantities (i.e., spatial dimensions) may be used explicitly or implicitly herein as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

In describing preferred and alternate embodiments of the technology described herein, specific terminology is employed for the sake of clarity. Technology described herein, however, is not intended to be limited to the specific terminology so selected, and it is to be understood that each specific element includes all technical equivalents that operate similarly to accomplish similar functions.

Described below are embodiments of a knife 100 with a miniature blade that is a line cutter 120 and methods for forming such. These products and methods generally include a knife blank 110 having a main blade 111 on one end and a line cutter 120 on the opposing end of a tang 115. The tang 115 is configured to be secured in a handle 130.

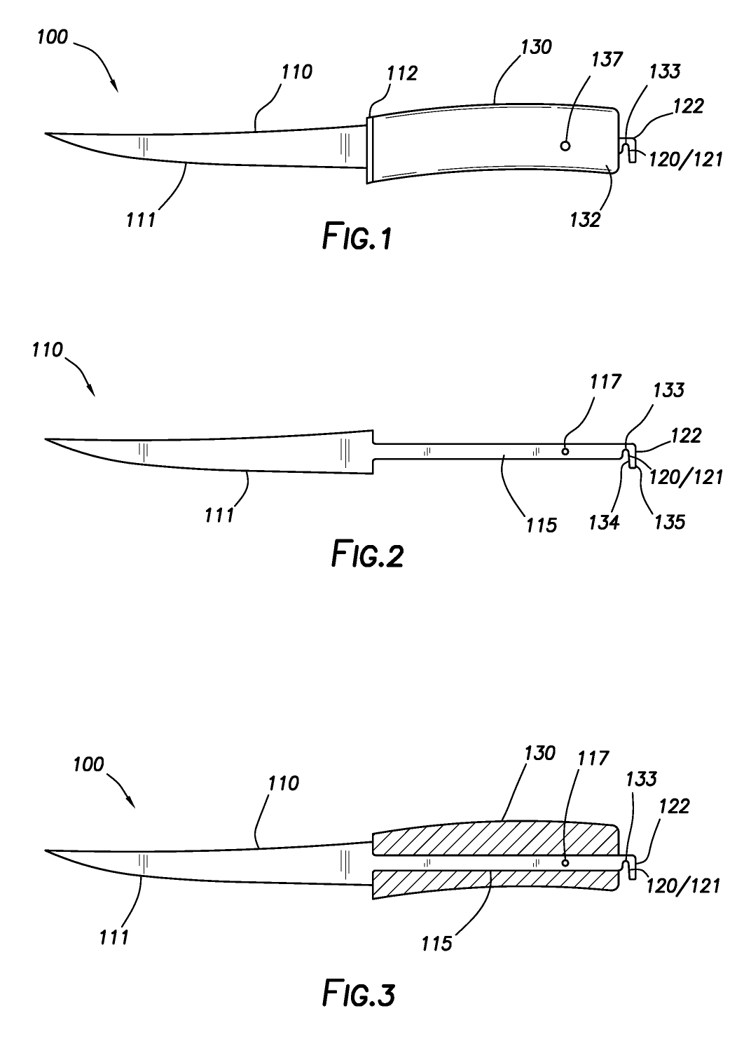

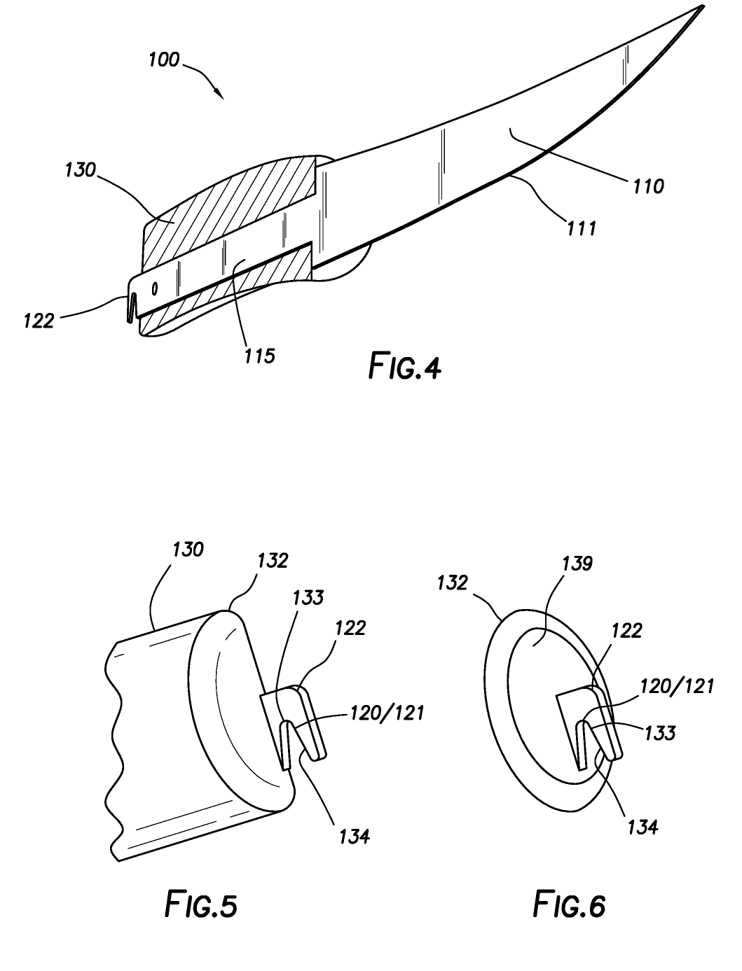

FIGS. 1-5 show a filet knife 100 comprising a handle 130 and a sharpened main blade 111. The knife may comprise a bolster 112. On the opposing end of the handle 130, at the heel of the pommel or butt 132 is a line cutter 120 disposed in a finger-shielding barrier, such as a hook 122 or other recessed, concave, or included-angle form extending from the butt end of the tang 115. More specifically in one embodiment, the line cutter 120 is located within a nook 133 formed by the inner curve or included angle of the hook 122. The hook 122 is configured to allow a fishing line to enter its nook 133 and has an inner cutting surface or sharpened edge 121 configured to engage and cut the line as the line is pulled against the sharpened edge 121. The interior wall(s) 134 of the nook 133 may be a combination of sharpened and unsharpened surfaces. The exterior surface or outer wall 135 of the hook 122 acts as a finger-shielding barrier and may have a flat finish, a rough finish, or other finish for realizing another fishing-related purpose.

In practice, a knife 100 is worn so that its butt 132 is facing generally upward and/or toward a fisherman so that he can easily see the line cutter 120 when he looks down. A purpose of the improvements embodied in the knife 100 with line cutter 120 is to provide a better alternative that allows a fisherman to cut a line quickly and cleanly, using their sheathed knife 100. The fisherman would simply pull his line over the butt 132 of his knife 100, into the nook 133, and across the inner cutting surface or sharpened edge 121 of the line cutter 120.

Current inferior options available to fishermen typically include: unsheathing a knife to cut the line; biting the line with one's teeth; grabbing a separate tool such as a nail clipper, pliers with cutter, etc.; or perhaps running the line across a portion of a blade lying flat against one's leg, which is awkward. With the present invention, the knife 100 remains sheathed and the hands remain free.

In a preferred embodiment, the knife 100 is formed from a knife blank 110 (see FIG. 2) that is stamped, laser cut, or otherwise formed out of metal, ceramic, or another suitable material, and the blank 110 comprises the main blade 111, a shaft or tang 115, and the line cutter 120 at the end of the tang 115 opposite the main blade 111. Stated a different way, the line cutter 120 may be formed as part of knife blank 110 at the end of the tang 115. Such one-piece formation makes for a sturdier knife 100 and straightforward and cost-efficient manufacturing and assembly. The tang 115 of the blank 110 may be straight or curved, and it is placed in the handle 130 and secured via one or more attachment members 137 (typically a rivet, screw, pin, epoxy, or other mechanical attachment) through one or more apertures 117. Other profiles and structures may aid securing of the handle 130 to the knife blank 110.

FIGS. 5-6 offer a closer view of the hook 122, which may have a “squared” or very rounded hook shape, or any hook shape that meets the required functionality and safety for the fisherman's hands. The size of the hook 122 may be made smaller or angled differently for safety. The sharpened edge 121 likewise may be of a variety of shapes that meet the needed function. FIG. 6 presents the line cutter 120 as an add-on for an existing knife, whether as part of a cap 139 that is secured to the butt 132 of a knife or as a stand-alone hook 122 that is hammered into a knife butt 132.

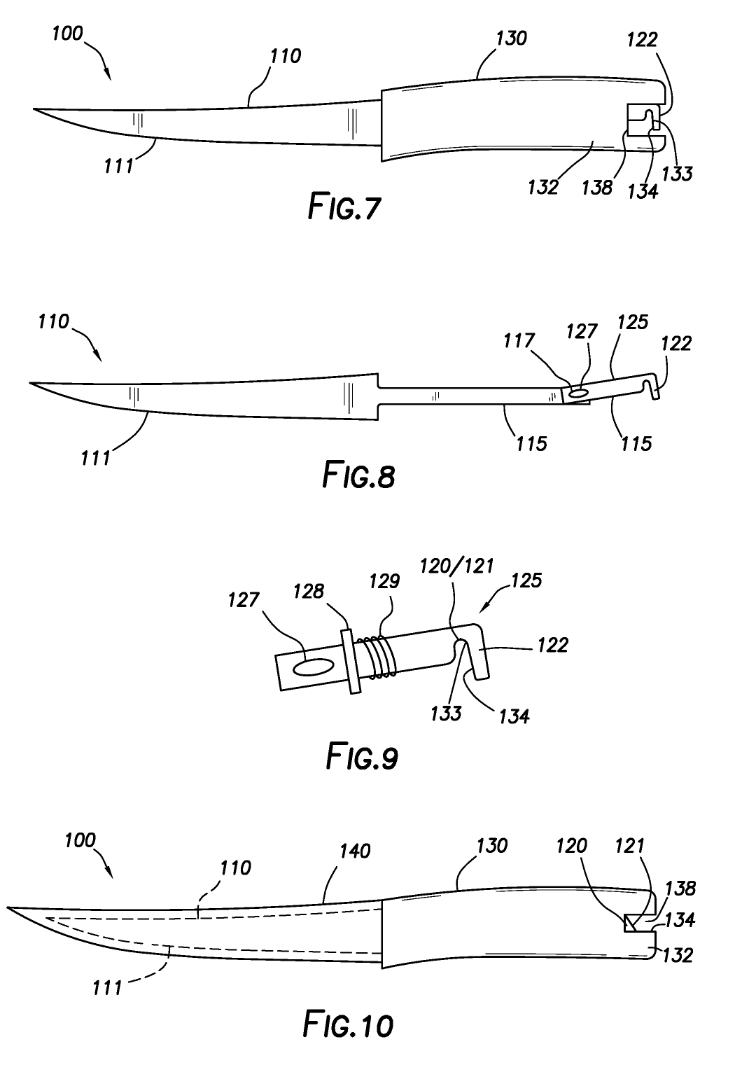

FIG. 7 presents the same line cutter 120 as inset or recessed into the handle 130. This relationship may be viewed two ways: as having the same knife blank 110 and a longer handle 130 than that of FIG. 1, or as having a shorter tang 115 and the same length of handle 130. Recessing the hook 122 within a nook 133 in the handle 130 helps protect the line cutter 120 from getting caught on clothing, a finger, etc.

FIG. 8 illustrates a tang extension or appendix 125 that provides a knife manufacturer with functional options. The tang appendix 125 may be viewed as a separate part and/or as part of the tang 115 itself. Thus the knife blank 110 (or assembly) of FIG. 8 may be the blank 110 of FIGS. 7 and 1-4 having a fixed length tang 115. Or, given a slidable and/or pivotable attachment of the tang extension or appendix 125 to the tang 115 at apertures 127 and 117, respectively, the tang appendix 125 may start in recessed position and extend outside of the handle 130 when needed, thus making the line cutter 120 retractable. Extension may be manually activated by the fishing line.

Additionally, as in FIG. 9, a spring 129 may be added to and a spring stop 128 formed with the tang appendix 125. As the appendix 125 is extended, the spring 129 compresses against the inside of the handle 130 and compels the tang appendix 125 to retract. Therefore, the line cutter 120 may project for temporary use and then retract. If a locking mechanism (not shown) is included, then the fisherman may lock the line cutter 120 in its extended position while fishing and then unlock and allow it to retract after fishing. The spring 128 may be made of metal, plastic, or another suitable material and is not limited to a traditional spring shape, but may include other materials such as water-resistant foams that provide spring-like resistance.

FIG. 10 presents an inset or recessed line cutter 120 that is a diagonal blade with sharpened edge 121 formed at the end of the knife blank 110 and located within a rectangular nook 133 at the butt 132. The line cutter 120 may have a removable cover (not shown). However, as with the hook 122, the configuration is intended to provide access to a fishing line while deterring access and injury to the user's fingers.

As with all configurations presented thus far, “miniature blade” refers to a line cutter 120 with a sharpened edge 121 that typically extends less than 1 inch along its longest dimension, and preferably less than 1/10 the length of the knife blank 110 (or less than ⅕ the length of the main blade 111). The handle 130 may be made of wood, but may also be made of a wide variety of materials including, but not limited to, plastic, antler, and composites. The main blade 111 shape and design is not limited to a filet knife, but may be any shape that is employed by fishermen and other outdoor explorers whose knives would benefit from a line cutter 120 as positioned and structured herein. This invention is not limited to fixed blade knives, but may also be applicable to folding knives.

In one embodiment, the sheath 140 and the knife 100 are weighted to pivot about a wearable mount, loop, or whatever means is used to attach the sheath 140 to a belt or pants, so that the butt 132 of the knife 100 is biased to point upward to be visible to the wearer. The direction the line cutter 120 hook 122 faces may be variable/rotatable as on a swivel or may be otherwise oriented in fixed position depending upon the knife 100 design. (For example, the inner cutting surface or sharpened edge 121 may face in the direction the fisherman is facing or may face the opposite direction, behind the fisherman, or to the fisherman's side.) Depending upon the orientation of the line cutter 120, the fisherman may either pull or push a line to be cut.

A method of creating a knife 100 with line cutter 120 as detailed in FIGS. 1-10 generally includes the following steps: forming a knife blank 110 comprising a blade 111, tang 115, and line cutter 120 with sharpened edge 121; forming a handle 130; inserting the tang 115 into the handle 130 such that the line cutter 120 is visible at the butt 132 of the knife 100; and securing the knife blank 110 to the handle 130. During production of knife blanks 110, patterns are configured to minimize waste. The method of insertion may vary based upon the shape of the tang 115 and handle 130, including full tang 115, half tang 115, one-piece handle 130, two-piece handle 130, and/or other forms of tang 115 and handle 130. In this method, certain of the steps are optional, and the order of the steps may in many instances be re-arranged.

It will be understood that many modifications could be made to the embodiments disclosed herein without departing from the spirit of the invention. Having thus described exemplary embodiments of the present invention, it should be noted that the disclosures contained in the drawings are exemplary only, and that various other alternatives, adaptations, and modifications may be made within the scope of the present invention. Accordingly, the present invention is not limited to the specific embodiments illustrated herein, but is limited only by the following claims.

I claim:

1. A knife comprising:
a handle;
a main blade located at one end of the handle; and
a line cutter located at the butt of the handle;
wherein the line cutter is configured to be accessed by a fishing line while the knife is sheathed and shielded to minimize a risk of injury to a user's fingers.

2. The knife of claim 1, further comprising a tang, wherein the main blade is formed on one end of the tang and the line cutter is formed on the other end of the tang, the tang configured to be secured in the handle.

3. The knife of claim 1, further comprising a nook formed in the butt of the handle, wherein the line cutter is located within the nook.

4. The knife of claim 3, wherein the nook is configured to allow a fishing line to be inserted and pulled across the line cutter.

5. The knife of claim 1, further comprising a finger-shielding barrier, wherein the line cutter is formed along a concave or included-angle boundary of the finger-shielding barrier.

6. The knife of claim 5, wherein the finger-shielding barrier is a hook extending from the butt of the handle, having an inner curve, and comprising the line cutter at a sharpened portion of the hook within the nook of the inner curve.

7. The knife of claim 6, wherein the hook is retractable.

8. The knife of claim 6, wherein the hook is located on a cap that is attached to the butt.

9. The knife of claim 1, wherein the line cutter is recessed inside the butt of the handle.

10. A knife blank comprising:
a tang;
a main blade formed at one end of the tang; and
a line cutter formed at the opposite end of the tang;
wherein the tang is configured to be secured in a handle; and
wherein the line cutter is configured to be exposed at the butt of the handle.

11. The knife blank of claim 10, wherein the line cutter is no more than 1/10^{th} the length of the tang.

12. The knife blank of claim 10, wherein the line cutter comprises a sharpened portion of an inner curve of a hook formed at the end of the tang.

13. The knife blank of claim 10, wherein the tang comprises first and second pieces, the first piece comprising at least the main blade, and the second piece comprising at least the line cutter.

14. The knife blank of claim 13, wherein the second piece is configured to extend and retract with respect to the first piece.

15. The knife blank of claim 10, wherein the line cutter is configured to be recessed inside the butt of the handle.

16. A knife comprising:
a handle;
a main blade located at one end of the handle; and
a retractable line cutter located in a nook at the butt of the handle;
wherein the line cutter is configured to be accessed by a fishing line while the knife is sheathed.

17. The knife of claim 16, wherein the nook is configured to allow a fishing line to be inserted into and pulled across the retractable line cutter as the line cutter is extended.

18. The knife of claim 16, wherein the retractable line cutter comprises a sharpened portion of an inner curve or included angle of a hook.

19. The knife of claim 16, further comprising a member having spring-like resistance configured to hold the retractable line cutter in retracted position until a fishing line is pulled across the hook.

20. The knife of claim 16, further comprising a sheath.
